(19) United States
(12) Patent Application Publication
(10) Pub. No.: US 2009/0274203 A1
(43) Pub. Date: Nov. 5, 2009

(54) Measuring Method and Device for Evaluating an OFDM-Multi-Antenna Transmitter

(75) Inventors: Heinz Mellein, Haar (DE); Pawel Telega, Riemerling (DE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Rohde & Schwarz GmbH & Co. KG, Muenchen (DE)

(21) Appl. No.: 12/296,548

(22) PCT Filed: Oct. 11, 2007
(86) PCT No.: PCT/EP2007/008858

§ 371 Date: Oct. 17, 2008

(30) Foreign Application Priority Data
Dec. 5, 2006 (DE) 10 2006 057 316.1

(51) Int. Cl. H04B 3/46; H04L 27/28

(52) U.S. Cl. 375/226; 375/260

(57) ABSTRACT

A method provides for evaluating the power performance of an OFDM multi-antenna transmitter, wherein a sum signal formed according to the WiMAX standard and transmitted from the multi-antenna transmitter, which represents a superposition of a preamble transmitted signal from a preamble transmit antenna of the multi-antenna transmitter and of at least one transmitted signal from a further transmit antenna of the multi-antenna transmitter, is transmitted via a transmission channel. A test receiver is phase-synchronized relative to the preamble transmit antenna on the basis of a preamble of the preamble transmitted signal, and a relative phase error between the transmitted signals is determined on the basis of a modulation method used for the transmission channel, the preamble and the error-vector magnitude (SEVM) calculated from the sum signal. A device for implementing the method is also provides.

The invention relates to a method for evaluating an OFDM multi-antenna transmitter and a device for the implementation of the method.

In general, wireless data-transmission systems provide information-carrying, modulated signals, which are transmitted wirelessly from one or more transmission sources, especially from a multi-antenna transmitter, to one or more receivers within a territory or region. Multi-antenna transmission systems are used primarily in order to increase the transmission capacity and the transmitted data rate.

Within the OFDM multi-antenna transmission system, a particularly error-free data transmission can be achieved using preamble structures, which are transmitted together with the data. A method for generating preamble structures for a MIMO-OFDM system is known from DE 10 2004 038 834 A1.

In the context of DE 10 2004 038 834 A1, the preamble structure is used only for phase synchronization of the receiver with the transmitter and for channel estimation to allow an accurate detection of the OFDM symbols received by the receiver.

The invention is based on the object of providing a method and a device, with which the power performance of a multi-antenna transmitter can be determined in a particularly rapid and reliable manner on the basis of the transmitted signal, which is transmitted from the multi-antenna transmitter especially using the WiMAX standard according to IEEE 802.16.

With reference to the method, this object is achieved according to the invention by the features of claim 1. Advantageous further developments provide the subject matter of the dependent claims referring back to claim 1.

With reference to the device, the object is achieved by the features of claim 8. Advantageous further developments provide the subject matter of the dependent claims referring back to claim 8.

In particular, the advantages achieved with the invention are that the method according to the invention can be implemented for any required large number of transmit antennas provided in a multi-antenna system. Since the error-vector magnitude (SEVM) correlates in a linear manner with the relative phase error between the transmitted signals, the error-vector magnitude (SEVM) is particularly suitable for determining the phase error. Furthermore, a determination of the phase error can be implemented in the test receiver without diversity decoding. The method according to the invention can also be implemented for every type of modulation.

An exemplary embodiment of the invention is described in greater detail below with reference to the drawings. The drawings are as follows:

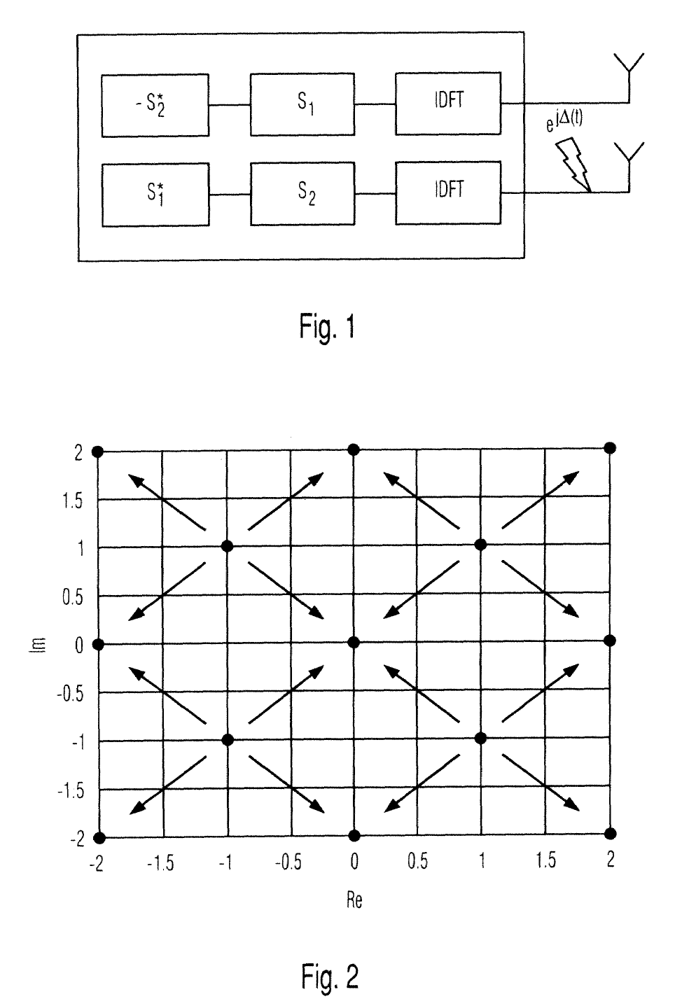

FIG. 1 shows a transmission arrangement with phase instabilities;

FIG. 2 shows the constellation of a two-antenna transmission arrangement;

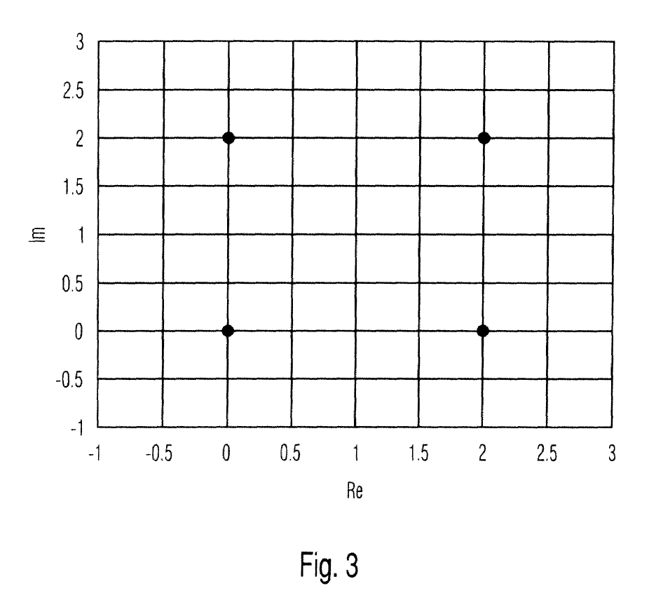

FIG. 3 shows the quarter under consideration of the constellation according to FIG. 2;

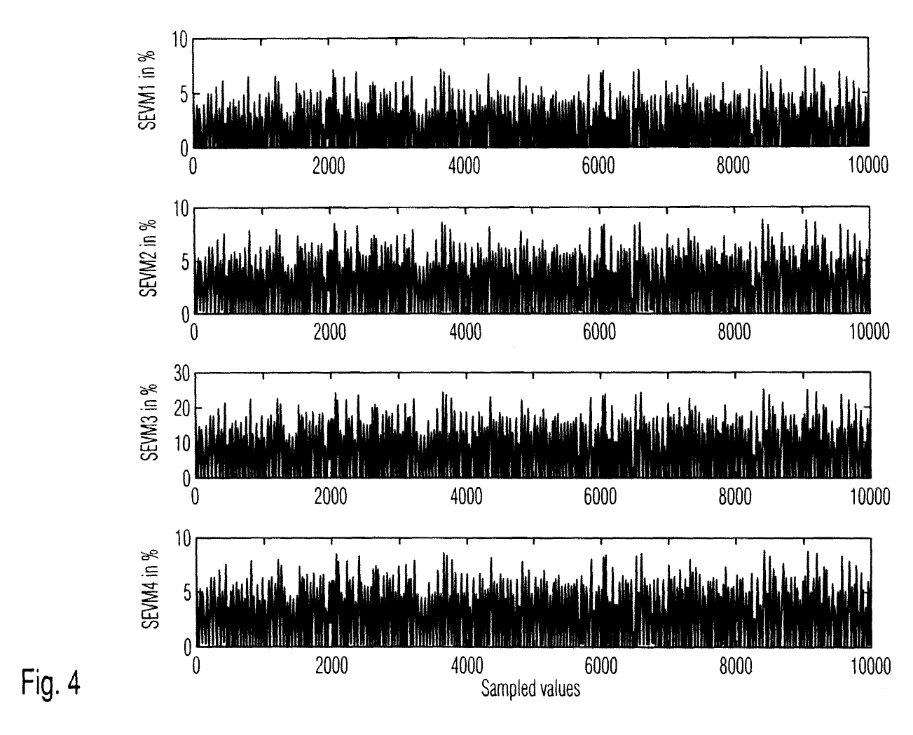

FIG. 4 shows SEVM characteristics for possible vectors;

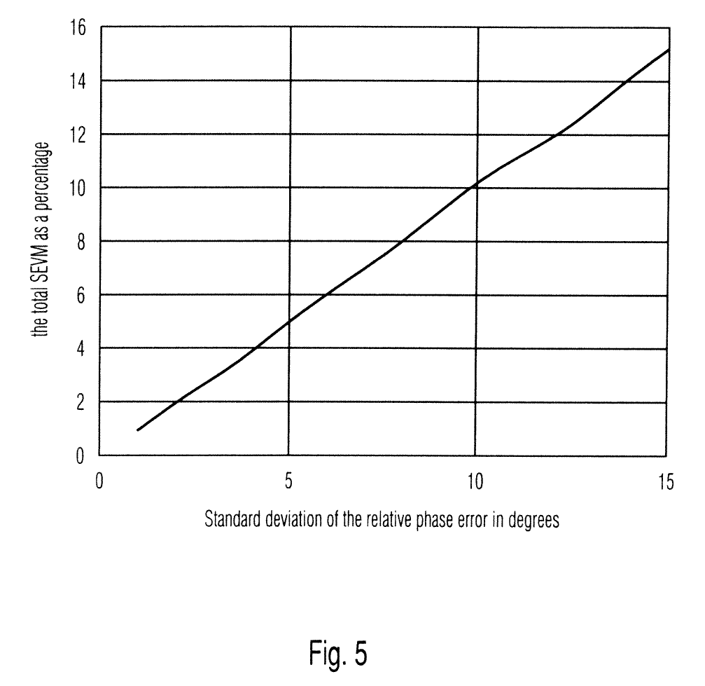

FIG. 5 shows the dependence of the total SEVMᵣₘₛ upon the standard deviation of the normally-distributed, relative phase error;

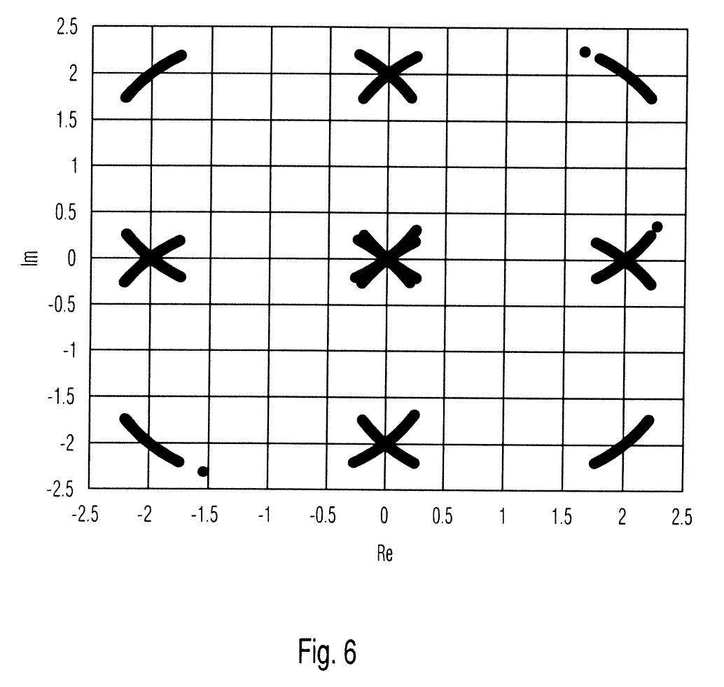

FIG. 6 shows the constellation diagram for the superposition of transmission signals;

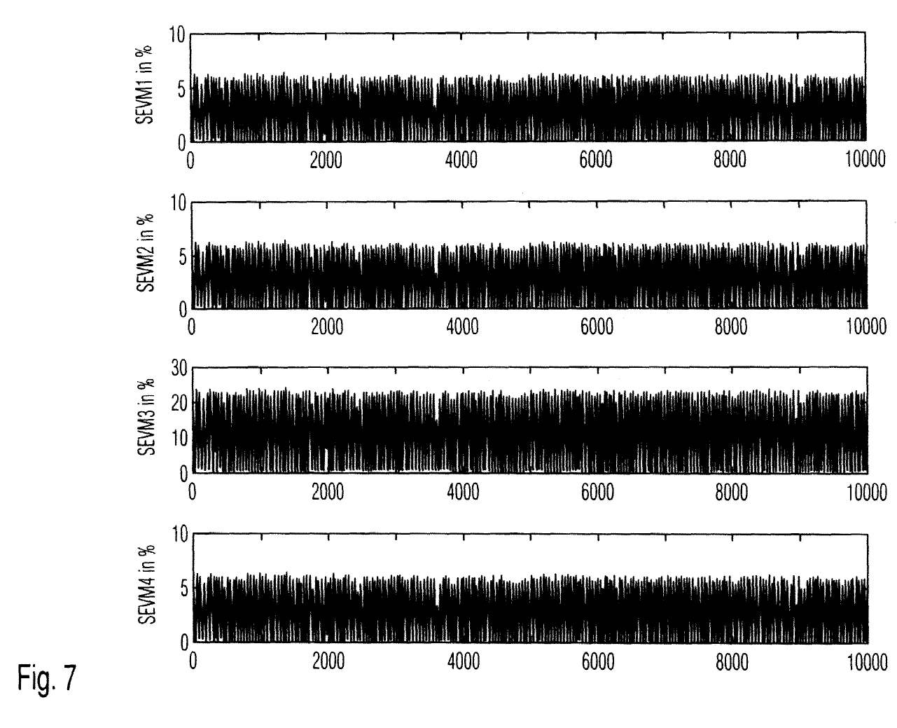

FIG. 7 shows SEVM characteristics in the case of a uniform distribution;

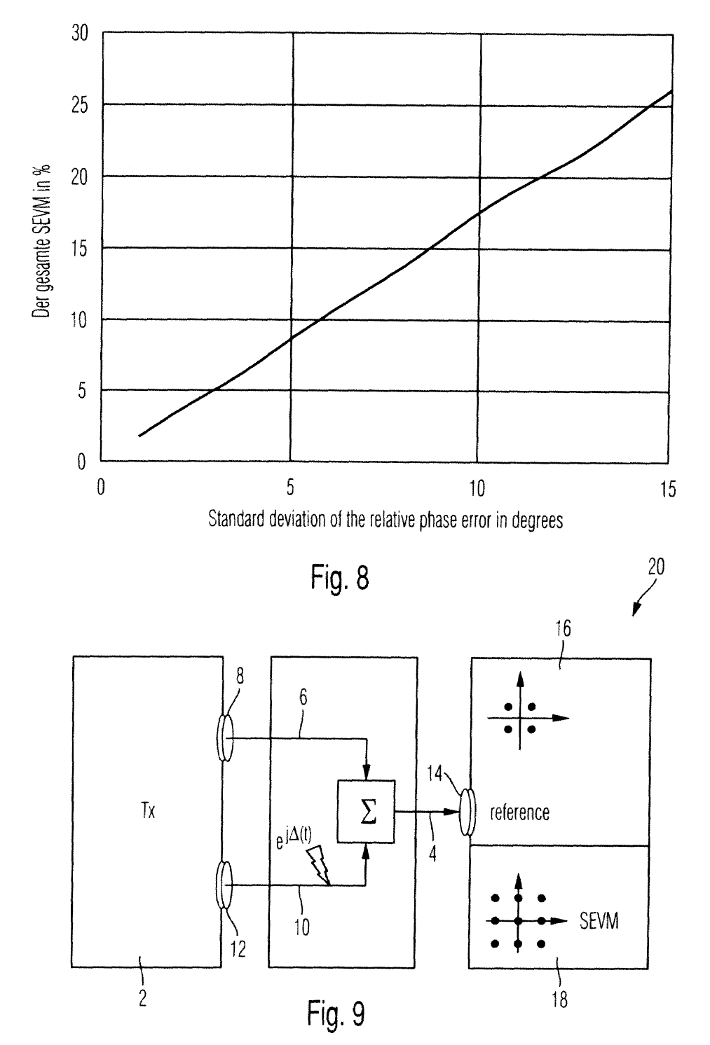

FIG. 8 shows the dependence of the total EVMᵣₘₛ upon the standard deviation of the uniformly-distributed, relative phase error; and

FIG. 9 shows a block-circuit diagram of the SEVM measurement.

For test purposes, the influence of the relative phase error on the properties of a multi-antenna transmitter can be investigated using the example of a WIMAX IEEE 802.16 signal. The Alamouti method known from Alamouti, S.M.: “A simple transmit diversity technique for wireless communications”, IEEE J. Sel. Areas Commun., 1999. 16, pp. 1451-1458 will first be presented. In this context, the influence of a non-ideal channel estimation on the orthogonality of the Alamouti matrix will then be demonstrated. The influence of a non-ideal phase behavior in the transmitter on the Alamouti matrix will also be considered. It will be shown that there is a linear correlation between the relative phase error in the transmitter and the evaluation of an EVM measurement of the sum signal (superposition of all antenna signals), as defined below. Accordingly, this test method—referred to as the SEVM—is presented as a simple and rapid possibility for evaluating the quality of a multi-antenna transmitter. The advantage of this method is in its independence from the actual space-time coding. It is a prerequisite that the test receiver is designed to synchronize to a reference antenna of the multi-antenna system. This is possible, for example, with a WiMAX signal according to IEEE 802.16. In each case, one antenna transmits exclusively one unambiguous preamble of known content.

The transmit diversity method proposed by Alamouti provides a less-complex alternative to the known receive-diversity method MRC (Maximum Ratio Combining). The Alamouti method also achieves a second-order diversity, which, by contrast with the MRC method, is implemented in the transmitter. The transmission arrangement was suggested by Alamouti.

According to Alamouti, two successive modulation symbols are observed in the receiver after the transmission via a DISO (Dual Input Single Output) channel. By way of simplification, the two received symbols are given in matrix form by equation (1).

$$( \begin{matrix}{R}_{1} \\ {R}_{1}^{*}\end{matrix} ) = \frac{1}{\sqrt{2}} {\underbrace{( \begin{matrix}{h}_{1} & {h}_{2} \\ {h}_{2}^{*} & - {h}_{1}^{*}\end{matrix} )}}_{{H}_{Al}} ( \begin{matrix}{S}_{1} \\ {S}_{2}\end{matrix} ) + ( \begin{matrix}{n}_{1} \\ {n}_{2}^{*}\end{matrix} ) \qquad ( 1 )$$

The matrix H_{Al} is referred to as the Alamouti matrix and is a scaled unitary matrix. In order to detect the two transmitted OFDM symbols, the reception vector is multiplied by the Hermite polynomial of the Alamouti matrix. The result is shown in equations (2) and (3). It is evident that, in the ideal case, the symbols can be detected without crosstalk, and each symbol profits optimally from both channel coefficients.

$$\begin{matrix}( \begin{matrix}{Y}_{1} \\ {Y}_{2}\end{matrix} ) = \frac{1}{\sqrt{2}} {H}_{Al}^{H} {H}_{Al} ( \begin{matrix}{S}_{1} \\ {S}_{2}\end{matrix} ) + {H}_{Al}^{H} ( \begin{matrix}{n}_{1} \\ {n}_{2}^{*}\end{matrix} ) & ( 2 ) \\ ( \begin{matrix}{Y}_{1} \\ {Y}_{2}\end{matrix} ) = \frac{1}{\sqrt{2}} [ {\vert {h}_{1} \vert}^{2} + {\vert {h}_{2} \vert}^{2} ] ( \begin{matrix}{S}_{1} \\ {S}_{2}\end{matrix} ) + \overline{n} & ( 3 )\end{matrix}$$

The Alamouti method is an orthogonal method, because the matrix H_{Al}^{H}H_{Al} comprises only values on the diagonal.

In the case of the real (that is to say non-ideal) channel estimation in the receiver, it is now assumed that a phase error occurs. The estimated channel values can therefore be described as follows:

ĥ₁=h₁e^{j9}^{₁}

ĥ₂=h₂e^{j9}^{₂} (4)

If the received symbols are multiplied by the Hermite polynomial of the channel matrix, which provides the estimation error described, the following equation is obtained:

$$\begin{matrix}( \begin{matrix}{Y}_{1} \\ {Y}_{2}\end{matrix} ) = \frac{1}{\sqrt{2}} {\hat{H}}^{H} H ( \begin{matrix}{S}_{1} \\ {S}_{2}\end{matrix} ) + \overline{n} & ( 5 ) \\ \hat{H} = ( \begin{matrix}{h}_{1} {e}^{{j9}_{1}} & {h}_{2} {e}^{{j9}_{2}} \\ {h}_{2}^{*} {e}^{- {j9}_{2}} & {h}_{1}^{*} {e}^{- {j9}_{1}}\end{matrix} ) & ( 6 )\end{matrix}$$

The estimated values for the transmitted symbols are obtained from the above as follows:

$$( \begin{matrix}{Y}_{1} \\ {Y}_{2}\end{matrix} ) = \frac{1}{\sqrt{2}} ( \begin{matrix}{\vert {h}_{1} \vert}^{2} {e}^{- {jϑ}_{1}} + {\vert {h}_{2} \vert}^{2} {e}^{- {jϑ}_{2}} & {h}_{1} {h}_{2}^{*} {e}^{- {jϑ}_{2}} - {h}_{1} {h}_{2}^{*} {e}^{{jϑ}_{1}} \\ {h}_{2} {h}_{1}^{*} {e}^{- {jϑ}_{1}} - {h}_{2} {h}_{1}^{*} {e}^{{jϑ}_{2}} & {\vert {h}_{2} \vert}^{2} {e}^{- {jϑ}_{2}} + {\vert {h}_{1} \vert}^{2} {e}^{- {jϑ}_{1}}\end{matrix} ) ( \begin{matrix}{S}_{1} \\ {S}_{2}\end{matrix} ) + \overline{n} \qquad ( 7 )$$

As a result of the non-ideal channel estimation, the orthogonality is obviously lost. The received symbols can evidently no longer be detected in an ideal manner, that is to say, without crosstalk. It remains to be established that Alamouti the method is sensitive to a non-ideal channel estimation. A coherent phase relationship in the multi-antenna transmitter has so far been assumed. The following section shows that a relative phase error between the transmit antennas also has a negative influence on the system power performance.

Hitherto, the influence of a phase error in the channel estimation on the orthogonality and power performance of an Alamouti receiver has been investigated. The next section considers more closely the potential interference resulting from a non-coherent phase relationship between the transmit antennas in an Alamouti transmission. Initially, it will be assumed that the phase of two transmission signals differs by a random phase offset. It is sufficient to observe only the phase offset, because it is assumed that one of the participating transmitted signals comprises a reference symbol, as is the case, for example, with a WiMAX multiple transmitter system according to IEEE 802.16 with a so-called preamble. It is also therefore irrelevant, whether all transmission routes are operated by a common oscillator or each by its own oscillator. The transmission arrangement is illustrated in equation (8) and in FIG. 1.

$$s ( {t}_{2 n - 1} ) = \frac{1}{\sqrt{2}} ( \begin{matrix}{s}_{2 n - 1} \\ {s}_{2 n} {e}^{jΔ ( {t}_{2 n - 1} )}\end{matrix} ) \\ s ( {t}_{2 n} ) = \frac{1}{\sqrt{2}} ( \begin{matrix}- {s}_{2 n} \\ {s}_{2 n - 1}^{*} {e}^{jΔ ( {t}_{2 n} )}\end{matrix} ) \qquad ( 8 )$$

Especially in the case of the OFDM signal considered here, if the conditions are observed in the frequency domain, the time multiplication corresponds to the time-variant phase offset of a convolution operation. If it is assumed—as with Alamouti—that the phase error remains constant in the transmitter for the duration of two modulation symbols, the two successive transmitted symbols (or respectively received symbols in the case of an otherwise error-free transmission) are obtained in the frequency domain at the odd and even timing points as follows:

$${R}_{2 n - 1} ( p ) = \frac{1}{\sqrt{2}} \{ \begin{matrix}{h}_{1 , 2 n - 1} {S}_{2 n - 1} ( p ) + \\ {h}_{2 , 2 n - 1} {S}_{2 n} ( p ) * DFT \{ {e}^{{jΔ}_{2 n - 1} ( p )} \}\end{matrix} \} \\ {R}_{2 n} ( p ) = \frac{1}{\sqrt{2}} \{ \begin{matrix}- {h}_{1 , 2 n} {S}_{2 n}^{*} ( p ) + \\ {h}_{2 , 2 n} {S}_{2 n - 1}^{*} ( p ) * DFT \{ {e}^{{jΔ}_{2 n} ( p )} \}\end{matrix} \} \qquad ( 9 )$$

In this context R₂ₙ₋₁(p) and R₂ₙ(p) are the actually-receivable OFDM symbols at the odd and even timing points; p is allocated to the current carrier within an OFDM symbol. With reference to equation (9), the evaluation of these symbols is implemented in the frequency domain. Inter-carrier interference (ICI) occurs because the convolution causes a broadening of the carrier signals. This interference is attributable to the mutual disturbance, that is to say, the orthogonality of the carrier signals already disturbed in the transmitter. It can be established that a time-variant phase error brings about a broadening of the carrier signals because of the convolution in the frequency domain and therefore also destroys the orthogonality of the carrier signals.

Now, if the convolution in equation (9) is considered more closely, it can be established that only the time variance of the phase noise causes an inter-carrier-interference. However, if it is assumed that the phase error remains constant for the duration of the channel estimation, that is to say, for the duration of one OFDM frame, for which the evaluation of the received signal is implemented, equation (9) adopts the following form:

$${R}_{2 n - 1} ( p ) = \frac{1}{\sqrt{2}} \{ {h}_{1} {S}_{2 n - 1} + {h}_{2} {S}_{2 n} * DFT \{ {e}^{jΔ} \} \} \\ {R}_{2 n} ( p ) = \frac{1}{\sqrt{2}} \{ - {h}_{1} {S}_{2 n}^{*} + {h}_{2} {S}_{2 n - 1}^{*} * DFT \{ {e}^{jΔ} \} \} \qquad ( 10 )$$

In this context, it is even assumed that the channel coefficients are constant for the duration of two OFDM symbols. The OFDM symbols can be considered independently from the individual carriers because the relative phase error remains constant for the duration of the signal evaluation. This is visualised in equation (10) by the disappearance of p. Equation (10) can now be further simplified by replacing the convolution with a multiplication. It is entirely possible that the phase component is no longer time variant, but can be seen as a constant. Equation (10) can therefore be transformed as follows:

$${R}_{2 n - 1} = \frac{1}{\sqrt{2}} \{ {h}_{1} {S}_{2 n - 1} + {h}_{2} {S}_{2 n} {e}^{jΔ} \} \\ {R}_{2 n} = \frac{1}{\sqrt{2}} \{ - {h}_{1} {S}_{2 n}^{*} + {h}_{2} {S}_{2 n - 1}^{*} {e}^{jΔ} \} \qquad ( 11 )$$

Equation (11) can then be presented in matrix form:

$$( \begin{matrix}{R}_{2 n - 1} \\ {R}_{2 n}\end{matrix} ) = \frac{1}{\sqrt{2}} ( \begin{matrix}{h}_{1} & {h}_{2} {e}^{jΔ} \\ {h}_{2}^{*} {e}^{- jΔ} & - {h}_{1}^{*}\end{matrix} ) ( \begin{matrix}{S}_{2 n - 1} \\ {S}_{2 n}\end{matrix} ) \qquad ( 12 )$$

The received symbols are now multiplied by the Hermite polynomial of the Alamouti matrix, the values of which are obtained after the channel estimation, in order to separate the data again in the receiver:

$$\begin{matrix}( \begin{matrix}{Y}_{2 n - 1} \\ {Y}_{2 n}\end{matrix} ) = \frac{1}{\sqrt{2}} {H}^{H} H ( \begin{matrix}{S}_{2 n - 1} \\ {S}_{2 n}\end{matrix} ) \\ = \frac{1}{\sqrt{2}} ( \begin{matrix}{\vert {h}_{1} \vert}^{2} + {\vert {h}_{2} \vert}^{2} & 0 \\ 0 & {\vert {h}_{1} \vert}^{2} + {\vert {h}_{2} \vert}^{2}\end{matrix} ) ( \begin{matrix}{S}_{2 n - 1} \\ {S}_{2 n}\end{matrix} )\end{matrix} \qquad ( 13 )$$

The result is particularly relevant for test purposes. In fact, it shows that so long as the phase error remains time-invariant for the duration of the signal evaluation, that is to say, in this case, for the duration of the channel estimation, the symbols can be separated again in the receiver without crosstalk. This result can be established on the basis of the diagonal structure of the upper matrix. It is particularly relevant for the purpose of the test to establish whether there is a time variance with reference to the relative phase between the transmit antennas, in order to allow a quality judgment regarding the multi-antenna transmitter.

With regard to further considerations, it will be assumed that the relative phase error is time variant, that is to say, it is different for all OFDM symbols, but remains constant for the duration of one OFDM symbol, so that the convolution in equation (9) can be replaced by a multiplication. The influence of a time-variant phase error of this kind on the power performance of the transmitter can now be established. A test method, which is based upon the known EVM measurement, but which is specially modified for multi-antenna transmitters, is therefore proposed.

The correlation between a relative, time-variant phase error, or respectively the statistical parameters of its distribution density, and a superposition-error-vector-magnitude (SEVM), which describes the latter and which is still to be defined, will now be derived. As already mentioned, for example, in the case of a WiMAX signal, the transmit antenna providing the preamble can be used as a reference. Accordingly, observations can be reduced exclusively to the phase difference. Two different distributions of the relative phase error are assumed by way of example. Initially, an average-free normal distribution is assumed; after this, a uniform distribution of the phase difference is assumed. The results are then compared. Accordingly, the following applies for the normal distribution:

θεN(0,σ) (14)

A practicable definition of the SEVM will now be presented for the case of a multi-antenna transmitter. A QPSK modulation is taken as an example for this purpose, that is to say, there are four possible constellation points per transmit antenna. Since the symbols from two antennas are added (for example, according to the Alamouti method), each of the four constellation points of an antenna is a possible starting point for the other four modulation symbols. The arrangement is illustrated in FIG. 2.

If all of the constellation points are taken to be of equal probability, the observation can be limited to one quadrant, as shown in FIG. 3.

In general, the EVM is defined as the quotient of the modulus of the error vector (difference vector made up from the actual [IST] and set [SOLL] vector) and the modulus of the set [SOLL] vector. However, with this definition, starting from the constellation for a two-antenna transmitter, as shown in FIG. 3, a division by precisely zero is obtained, if the two antennas transmit with the same power. A matched definition is required in order to avoid the division by zero. Because the set [SOLL] vector is obtained from the sum of two vectors or respectively from the sum of the vectors of all Tx antennas, the set [SOLL] vector modulus, which is used for the division, is also defined as the sum of all moduli. In this case, the modulus of the set [SOLL] vector for the QPSK symbol 0+j0 is no longer zero, but equal to 2\sqrt{2}. This also applies for all other possible sum symbols. The following equation therefore applies for the actual [IST] vector for the first possibility within the assumed quarter of the constellation:

\vec{V}_{1,ist}=\sqrt{2}e^{j45°}+\sqrt{2}e^{j45°}e^{jΔ}=\sqrt{2}e^{j45}°(1+e^{jΔ}) (15)

and, by analogy, the following equations are obtained for the other three possibilities:

\vec{V}_{2,ist}=\sqrt{2}e^{j45°}+\sqrt{2}e^{-j45°}e^{jΔ}=\sqrt{2}e^{j45}°(1−je^{jΔ}) (16)

\vec{V}_{3,ist}=\sqrt{2}e^{j45°}+\sqrt{2}e^{-j135°}e^{jΔ}=\sqrt{2}e^{j45}°(1−je^{jΔ}) (17)

\vec{V}_{4,ist}=\sqrt{2}e^{j45°}+\sqrt{2}e^{-j135°}e^{jΔ=\sqrt{2}e}^{j45}°(1+je^{jΔ}) (18)

The SEVM can be defined for a given timing point and differently for the four possibilities mentioned, as follows:

$$\begin{matrix}{sevm}_{1} = \vert \frac{\sqrt{2} {e}^{j45°} ( 1 + {e}^{jΔ} ) - 2 \sqrt{2} {e}^{j45°}}{2 \sqrt{2} {e}^{j45°}} \vert = \vert \frac{( 1 + {e}^{jΔ} )}{2} - 1 \vert & ( 19 ) \\ {sevm}_{2} = \vert \frac{\sqrt{2} {e}^{j45°} ( 1 + {je}^{jΔ} ) - 2}{2 \sqrt{2}} \vert = \vert \frac{\sqrt{2} {e}^{j45°} ( 1 + {je}^{jΔ} )}{2} - 1 \vert & ( 20 ) \\ {sevm}_{3} = \vert \frac{\sqrt{2} {e}^{j45°} ( 1 + {e}^{jΔ} ) - 0}{2 \sqrt{2}} \vert = \vert \frac{{e}^{j45°} ( 1 - {e}^{jΔ} )}{2} \vert & ( 21 ) \\ {sevm}_{4} = \vert \frac{\sqrt{2} {e}^{j45°} ( 1 + {je}^{jΔ} ) - 2 {e}^{j90°}}{2 \sqrt{2} {e}^{j90°}} \vert = \vert \frac{\sqrt{2} {e}^{j45°} ( 1 + {je}^{jΔ} )}{j2} - 1 \vert & ( 22 )\end{matrix}$$

In order to make a statement regarding the power performance of a transmitter, the SEVM, can now be defined as follows:

$${sevin}_{rms} = \sqrt{\frac{{\sum }_{i} {\vert {\vec{V}}_{ist} ( i ) - {\vec{V}}_{soll} \vert}^{2}}{\sum {\vert {\vec{V}}_{soll} \vert}^{2}}} \qquad ( 23 )$$

The following equations are obtained for the quantity of possible vectors:

$$\begin{matrix}{sevm}_{rms , 1} = \sqrt{\frac{{\sum }_{i = 1}^{N} {\vert {e}^{jΔ ( i )} - 1 \vert}^{2}}{4 N}} & ( 24 ) \\ {sevm}_{rms , 2} = \sqrt{\frac{{\sum }_{i = 1}^{N} {\vert \sqrt{2} {e}^{j45°} ( 1 - {je}^{jΔ ( i )} ) - 2 \vert}^{2}}{8 N}} & ( 25 ) \\ {sevm}_{rms , 3} = \sqrt{\frac{{\sum }_{i = 1}^{N} {\vert {e}^{j45°} ( 1 - {e}^{jΔ ( i )} ) \vert}^{2}}{4 N}} & ( 26 ) \\ {sevm}_{rms , 4} = \sqrt{\frac{{\sum }_{i = 1}^{N} {\vert \sqrt{2} {e}^{j45°} ( 1 + {je}^{jΔ ( i )} ) - 2 {e}^{j90°} \vert}^{2}}{8 N}} & ( 27 )\end{matrix}$$

For a random sequence of normally-distributed phase offsets, a linear increase of the SEVMᵣₘₛ with a rising standard deviation can be observed. An example of the SEVM sequences for a standard deviation of 20 and for the four possible constellations is presented in FIG. 4. In this context, all of the SEVMᵣₘₛ are the same:

SEVM_{rms,1}=1.75% SEVM_{rms,2}=1.75%

SEVM_{rms,3}=1.75% SEVM_{rms,4}=1.75%

The total SEVMᵣₘₛ is therefore also 1.75%. Although the SEVMᵣₘₛ remains small for small standard deviations, the maximum value of the SEVM, as shown in FIG. 4, is equal to approximately 25%. If the standard deviation of the relative phase error is increased, the total SEVMᵣₘₛ increases. The linear dependence of the total SEVMᵣₘₛ is presented in FIG. 5.

The constellation of the superposition of transmitted signals for the case of a 50 standard deviation of the relative phase error is presented in FIG. 6. Now, if a uniform distribution is considered instead of a normally-distributed phase difference, then it will be noticed that a linear dependence of the total SEVMᵣₘₛ upon the standard deviation or respectively the interval is also observed. The following applies for the standard deviation of the uniform distribution:

$$σ = \frac{1}{2 \sqrt{3}} Ψ \qquad ( 28 )$$

wherein Ψ is the uniformly-distributed interval. In order to compare the results with the normal distribution in a meaningful manner, we assume the same standard deviation of 2°. An interval of the relative phase error of approximately 7° is obtained. Accordingly, all of the SEVMᵣₘₛ and also the total SEVMᵣₘₛ are equal to 3.5%. It is striking that in the case of a uniformly-distributed phase error for the same standard deviation of 20, the SEVMᵣₘₛ is double the magnitude by comparison with the normal distribution. The random time characteristic of the SEVM and the dependence of the total SEVMᵣₘₛ upon the standard deviation in the case of a uniform distribution are presented in FIGS. 7 and 8 respectively.

By analogy, it can be shown that similar values are obtained for the SEVM of any required QAM modulation. In this context, it must be mentioned that although the SEVM for any required QAM constellation remains the same, the probability of an error detection in the receiver increases with an increasing degree of QAM modulation.

It has been shown that there is a direct correlation between the relative phase error and the SEVM presented. The SEVM measurement provides information regarding the properties of a multi-antenna transmitter for any required transmit-diversity coding. Only a reference symbol, such as the preamble in a WiMAX signal, on exclusively one of the transmit antennas is assumed. The results of the SEVM measurement can be attributed directly to the imperfect phase relationship between the transmit antennas.

The following section describes a possible structure for the test. A simple but informative test method for evaluating the properties of a multi-antenna transmitter is also presented. In general, this method can be implemented for any required number of transmit antennas and any type of modulation. However, the complexity increases in a linear manner with the number of antennas and exponentially with the increasing degree of modulation (in general, N-QAM). The method shown here is conceived particularly for a WiMAX signal, wherein only one transmit antenna is provided with a preamble in each case. The preamble is used for phase synchronization and phase equalization. The modulation symbols of the transmit antenna provided with the preamble can therefore be regarded as a reference for the symbols of a further antenna.

The SEVM measurement applies for every kind of space-time coding in the transmitter, that is to say, not only for the Alamouti method. Only the preamble needs to be known to the test receiver. The participating modulation types must also be known to the test receiver. Accordingly, the set [SOLL] vectors for the SEVM measurement are unambiguously specified.

One further advantage is that the measurement is implemented without diversity decoding (equalization) in the receiver. It is not necessary for the receiver to know which MIMO transmission method is used. The SEVM result is specified directly from the superposition of the two signals in the complex signal space.

FIG. 9 presents one possible test structure for an SEVM measurement on a WiMAX signal. The transmitted signals, which differ in phase by a relative error, are added. In this context, one antenna transmits the preamble mentioned above, while the second antenna does not send a signal at the same time (IEEE 802.16).

In order to evaluate the properties of the transmitter, the influence of the measurement channel must first be eliminated. It is assumed that all channel coefficients are equal to one. For this purpose, the system is calibrated accordingly before the implementation of the measurement, so that only the influence of the relative phase error between the signals is observed.

The receiver relates to the transmitted signal with the preamble and, at this timing point, manufacturers the reference-signal space for the superposition of the signals arriving from several antennas. The actual [IST] vectors can be calculated after the constellation of the multiple signal has been prepared. The SEVM values can be calculated according to the proposed definition, because the set [SOLL] vectors are also known to the receiver together with the modulation type.

One important question is which SEVM range can be assumed for a good receiver. In this context, a probability observation can be helpful. It can be proved, that the relative phase error between the signals acts like an AWGN channel for the equalised signal and can be subsumed within an observation of the probability theorem. For a system such as that presented in FIG. 9, that is to say, without the mobile-telephone channel, it is, of course, desirable that the bit-error probability should be as low as possible and, in the ideal case, should be zero after decoding. For a bit-error probability of 10-12, a standard deviation of approximately 6° is obtained for the normally-distributed relative phase error. If the characteristic shown in FIG. 5 is considered, it can be established, that the maximal SEVMᵣₘₛ in this case may amount to 6%. It must be mentioned that considerably smaller standard deviations and therefore lower SEVM values are obtained for the same bit-error probability and for higher modulation types (N-QAM). The condition of a good transmitter is therefore dependent upon requirements but also upon modulation type and the number of transmit antennas.

The invention is not restricted to the exemplary embodiment presented in the drawings. All of the features described above and illustrated in the drawings can be combined with one another as required.

1. Method for evaluating the power performance of an OFDM multi-antenna transmitter,
comprising transmitting a sum signal from a multi-antenna transmitter, which represents a superposition of a preamble transmitted signal from a preamble transmit antenna of the multi-antenna transmitter and transmitting at least one further transmitted signal from a further transmit antenna of the multi-antenna transmitter via a transmission channel,
phase-synchronizing a test receiver on the basis of a preamble of the preamble transmitted signal relative to the preamble transmit antenna, and
determining a relative phase error between the preamble transmitted signal and every further transmitted signal on the basis of a modulation method used for the transmission channel, the preamble, and the error-vector magnitude (SEVM) calculated from the sum signal.

2. Method according to claim 1,
comprising calculating
the error-vector magnitude (SEVM) from the quotient of a difference vector and a target vector \vec{V}ₛₒₗₗ.
wherein the difference vector is formed from an actual vector \vec{V}ᵢₛₜ directed to a constellation point of the transmitted signal and the target vector \vec{V}ₛₒₗₗ directed to the corresponding constellation point of the preamble transmitted signal.

3. Method according to claim 2,
comprising calculating
the error vector magnitude (SEVM) for the QPSK-modulation method with four constellation points from
$${sevin}_{rms} = \sqrt{\frac{{\sum }_{i} {\vert {\vec{V}}_{ist} ( i ) - {\vec{V}}_{soll} \vert}^{2}}{\sum {\vert {\vec{V}}_{soll} \vert}^{2}}} ,$$
wherein i=1 to 4.

4. Method according to
claim 1, comprising allocating
reference symbols, which are used as a reference for OFDM symbols of the further transmit antenna, to the preamble.

5. Method according to,
claim 1, comprising
with reference to time, before determining the relative phase error, eliminating the influence of the transmission channel by matching the channel coefficients.

6. Method according to,
claim 1, comprising using
the preamble transmitted signal in the test receiver for phase equalization of the sum signal.

7. Method according to,
claim 1, comprising holding
the relative phase error constant in the multi-antenna transmitter for the time duration of one OFDM symbol transmitted from the multi-antenna transmitter.

8. Device for evaluating the power performance of an OFDM multi-antenna transmitter, comprising
a test receiver for the reception of a sum signal, which represents a superposition of a preamble transmitted signal from a preamble transmit antenna of the multi-antenna transmitter and of at least one further transmitted signal from a further transmit antenna of the multi-antenna transmitter,
a synchronization device, which is designed to synchronize the test receiver in phase with the preamble transmit antenna on the basis of a preamble of the preamble transmitted signal,
and a signal-evaluation device for determining the relative phase error between the preamble transmitted signal and every further transmitted signal on the basis of a modulation method used for the transmission channel, the preamble and the error-vector magnitude (SEVM) calculated from the sum signal.

9. Device according to claim 8,
comprising
a calibration device for eliminating the influence of the transmission channel by matching the channel coefficients.

10. Device according to claim 8, wherein
the transmission channel is designed as a mobile telephone channel.

11. Method according to claim 1, comprising forming the sum signal according to the WiMax standard.

12. Device according to claim 10, wherein the transmission channel is designed as a mobile telephone channel for the WiMax standard.
